(19) United States
(12) Patent Application Publication
(10) Pub. No.: US 2009/0021470 A1
(43) Pub. Date: Jan. 22, 2009

(54) BACKLIGHT ASSEMBLY AND DISPLAY APPARATUS HAVING THE SAME

(76) Inventors: Kwang-Hee Lee, Seoul (KR); Jin-Woo Park, Cheonan-si (KR)

Correspondence Address: F. CHAU & ASSOCIATES, LLC, 130 WOODBURY ROAD, WOODBURY, NY, 11797, US

(21) Appl. No.: 12/243,603

(22) Filed: Oct. 1, 2008

(30) Foreign Application Priority Data
Jul. 11, 2007 (KR) 2007-113048

(51) Int. Cl. G09G 3/36

(52) U.S. Cl. 345/102

(57) ABSTRACT

A light-emitting part includes (N)-th row light-emitting diodes (LEDs) and (N+1)-th row LEDs, wherein ‘N’ is a natural number. A pulse width modulation (PWM) control part generates (N)-th and (N+1)-th PWM signals. A driving voltage generating part includes an (N)-th driving element that applies an (N)-th driving voltage to the (N)-th row LEDs, and an (N+1)-th driving element that applies an (N+1)-th driving voltage to the (N+1)-th row LEDs, wherein a phase of the (N+1)-th driving voltage is delayed by about 360 degrees/M with respect to the phase of the first driving voltage, wherein ‘M’ is a natural number that is more than 2. A current balance part controls an amplitude of an (N)-th driving current applied to the (N)-th row LEDs and an amplitude of (N+1)-th driving current applied to the (N+1)-th row LEDs. Therefore, a striped image may be prevented from being displayed on the display apparatus.

### CROSS-REFERENCE TO RELATED APPLICATION

This application claims priority under 35 U.S.C. § 119 to Korean Patent Application No. 2007-113048, filed on Nov. 7, 2007 in the Korean Intellectual Property Office (KIPO), the contents of which are herein incorporated by reference in their entirety.

### BACKGROUND OF THE INVENTION

1. Technical Field

The present disclosure relates to a backlight assembly and a display apparatus having the backlight assembly. More specifically, the present disclosure relates to a backlight assembly including a light-emitting diode (LED) and a display apparatus having the backlight assembly.

2. Discussion of Related Art

Generally, a liquid crystal display (LCD) device, among various flat panel display apparatus, offers advantages, such as thinness, lighter weight, lower driving voltage, and lower power consumption, compared to other kinds of display apparatus, such as cathode ray tube (CRT) devices, plasma display panel (PDP) devices, and the like. As a result, the LCD devices are widely employed for various electronic devices, such as a monitor, a lap top computer, a cellular phone, a big screen television set, and the like. The LCD device includes an LCD panel that displays an image using a light-transmitting ratio of liquid crystal molecules, and a backlight assembly disposed below the LCD panel to provide the LCD panel with light.

The LCD panel includes an array substrate, an opposite substrate and a liquid crystal layer between the two substrates. The array substrate includes a plurality of signal lines, a plurality of thin-film transistors (TFTs), and a plurality of pixel electrodes. The opposite substrate faces the array substrate and has a common electrode. The liquid crystal layer is interposed between the array substrate and the opposite substrate.

The backlight assembly includes a light source that emits a light, such as a cold cathode fluorescent lamp (CCFL), an external electrode fluorescent lamp (EEFL), a flat-type fluorescent lamp (FFL), and light-emitting diode (LED). The LED has favorable characteristics, such as low power consumption and high color reproducibility, so that the LED has been mainly used as the light source.

A plurality of LEDs is disposed on a driving substrate in a matrix shape, and is driven by a pulse width modulation (PWM) control method with a row unit. In this example, as the LEDs are driven by a PWM control signal, all of the LEDs may be turned off. That is, a dark period during which all of the LEDs are turned off may exist.

When lights generated from the backlight assembly are incident to the TFTs of the array substrate, a fine leakage current may be generated in respective channel layers of the TFTs. The leakage current, however, is not generated during the dark period, conventionally.

As the backlight assembly generates no light during the dark period, the leakage current may be non-sequentially and non-uniformly generated in the respective channel layer of the TFTs. Therefore, the display apparatus may display a striped image.

### SUMMARY OF THE INVENTION

Exemplary embodiments of the present invention provide a backlight assembly capable of removing a defect induced by a leakage current.

An exemplary embodiment of the present invention also provides a display apparatus having the backlight assembly.

In an exemplary embodiment of the present invention, a backlight assembly includes a light-emitting part, a pulse width modulation (PWM) control part, a driving voltage generating part, and a current balance part.

The light-emitting part includes a plurality of (N)-th row light-emitting diodes (LEDs) that are serially connected to each other, and a plurality of (N+1)-th row LEDs that are serially connected to each other, wherein ‘N’ is a natural number. The PWM control part generates an (N)-th PWM signal for controlling the (N)-th row LEDs, and an (N+1)-th PWM signal for controlling the (N+1)-th row LEDs. The driving voltage generating part includes an (N)-th driving element that applies an (N)-th driving voltage to the (N)-th row LEDs in response to the (N)-th PWM signal, and an (N+1)-th driving element that applies an (N+1)-th driving voltage to the (N+1)-th row LEDs in response to the (N+1)-th PWM signal, wherein a phase of the (N+1)-th driving voltage is delayed by about 360 degrees/M with respect to that of the first driving voltage, wherein ‘M’ is a natural number that is more than 2. The current balance part is electrically connected to the driving voltage generating part and the light-emitting part to control an amplitude of the (N)-th driving current that is applied to the (N)-th row LEDs and an amplitude of the (N+1)-th driving current that is applied to the (N+1)-th row LEDs.

In an exemplary embodiment, the PWM control part may control the driving voltage generating, so that the LEDs that are disposed in each row receive a driving voltage having an equal phase by the (N)-th row.

For example, the light-emitting part may include even numbered LEDs and odd numbered LEDs. The PWM control part may generate a first PWM signal for controlling the odd numbered LEDs and a second PWM signal for controlling the even numbered LEDs. The driving voltage generating part may include a first driving element that applies a first driving voltage to the odd numbered LEDs in response to the first PWM signal and a second driving element that applies a second driving voltage to the even numbered LEDs in response to the second PWM voltage, wherein a phase of the second driving voltage is delayed by about 180 degrees/M with respect to a phase of the first driving voltage. In this exemplary embodiment, M is 2.

In an exemplary embodiment, the current balance part may include a first balance part and a second balance part. The first balance part may be electrically connected to the first driving element and the odd numbered LEDs in order to control an amplitude of a first driving current that is applied to the odd numbered LEDs. The second balance part may be electrically connected to the second driving element and the even numbered LEDs in order to control an amplitude of a second driving current that is applied to the even numbered LEDs.

In an exemplary embodiment, the first balance part may include at least one of first current balance elements electrically connected to the odd numbered row LEDs. The second balance part may include at least one of second current balance elements electrically connected to the even numbered row LEDs.

For example, each of the first current balance elements may be electrically connected to two LEDs of the odd numbered LEDs, which are serially connected to each other and adjacent each other, and each of the second current balance elements may be electrically connected to two LEDs of the even numbered LEDs, which are serially connected to each other and adjacent each other.

For example, the (N)-th row LEDs may include a plurality of (N)-th row red LEDs that are serially connected to each other, a plurality of (N)-th row green LEDs that are serially connected to each other, and a plurality of (N)-th row blue LEDs that are serially connected to each other. The (N+1)-th row LEDs may include a plurality of (N+1)-th row red LEDs that are serially connected to each other, a plurality of (N+1)-th row green LEDs that are serially connected to each other, and a plurality of (N+1)-th row blue LEDs that are serially connected to each other.

The (N)-th PWM signal may include an (N)-th red PWM signal for controlling the (N)-th row red LEDs, an (N)-th green PWM signal for controlling the (N)-th row green LEDs, and an (N)-th blue PWM signal for controlling the (N)-th row blue LEDs. The (N+1)-th PWM signal may include an (N+1)-th red PWM signal for controlling the (N+1)-th row red LEDs, an (N+1)-th green PWM signal for controlling the (N+1)-th row green LEDs, and an (N+1)-th blue PWM signal for controlling the (N+1)-th row blue LEDs.

The (N)-th driving element may include an (N)-th red driving element applying an (N)-th red driving voltage to the (N)-th row red LEDs in response to the (N)-th red PWM signal, an (N)-th green driving element applying an (N)-th green driving voltage to the (N)-th row green LEDs in response to the (N)-th green PWM signal, and an (N)-th blue driving element applying an (N)-th blue driving voltage to the (N)-th row blue LEDs in response to the (N)-th blue PWM signal. The (N+1)-th driving element may include an (N+1)-th red driving element applying an (N+1)-th red driving voltage to the (N+1)-th row red LEDs in response to the (N+1)-th red PWM signal, wherein a phase of the (N+1)-th red driving voltage is delayed by about 360 degrees/M with respect to that of the (N)-th red driving voltage, an (N+1)-th green driving element applying a (N+1)-th green driving voltage to the (N+1)-th row green LEDs in response to the (N+1)-th green PWM signal, wherein a phase of the (N+1)-th green driving voltage is delayed by about 360 degrees/M with respect to that of the (N)-th green driving voltage, and an (N+1)-th blue driving element applying an (N+1)-th blue driving voltage to the (N+1)-th row blue LEDs in response to the (N+1)-th blue PWM signal, wherein a phase of the (N+1)-th blue driving voltage is delayed by about 360 degrees/M with respect to that of the (N)-th blue driving voltage. In this exemplary embodiment, M is 2.

The (N)-th driving current may include an (N)-th red driving current that is applied to the (N)-th row red LEDs, an (N)-th green driving current that is applied to the (N)-th row red LEDs, and an (N)-th blue driving current that is applied to the (N)-th row red LEDs. The (N+1)-th driving current may include an (N+1)-th red driving current that is applied to the (N+1)-th row red LEDs, an (N+1)-th green driving current that is applied to the (N+1)-th row red LEDs, and an (N+1)-th blue driving current that is applied to the (N+1)-th row red LEDs.

The current balance part may include an (N)-th balance part and an (N+1)-th balance part. The (N)-th balance part controls amplitudes of the (N)-th red driving current, the (N)-th green driving current, and the (N)-th blue driving current. The (N+1)-th balance part controls amplitudes of the (N+1)-th red driving current, the (N+1)-th green driving current and the (N+1)-th blue driving current.

The backlight assembly may further include a light-sensing part sensing a red light, a green light, and a blue light that are emitted from the light-emitting part to generate a red light control signal for controlling an amplitude of the red light, a green light control signal for controlling an amplitude of the green light and a blue light control signal for controlling an amplitude of the blue light. In this exemplary embodiment, the PWM control part controls the driving voltage generating part to control the amplitudes of the red, green, and blue lights in response to the red light control signal, the green light control signal and the blue light control signal, respectively.

In an exemplary embodiment of the present invention, a display apparatus includes a backlight assembly emitting light and a display panel displaying an image using the light generated from the backlight assembly. The backlight assembly includes a light-emitting part, a PWM control part, a driving voltage generating part and a current balance part.

The light-emitting part includes a plurality of (N)-th row light-emitting diodes (LEDs) that are serially connected to each other, and a plurality of (N+1)-th row LEDs that are serially connected to each other, wherein ‘N’ is a natural number. The PWM control part generates an (N)-th PWM signal for controlling the (N)-th row LEDs, and an (N+1)-th PWM signal for controlling the (N+1)-th row LEDs. The driving voltage-generating part includes an (N)-th driving element that applies an (N)-th driving voltage to the (N)-th row LEDs in response to the (N)-th PWM signal, and an (N+1)-th driving element that applies an (N+1)-th driving voltage to the (N+1)-th row LEDs in response to the (N+1)-th PWM signal, wherein a phase of the (N+1)-th driving voltage is delayed by about 360 degrees/M with respect to that of the first driving voltage, wherein ‘M’ is a natural number that is more than 2. The current balance part is electrically connected to the driving voltage-generating part and the light-emitting part in order to control an amplitude of the (N)-th driving current that is applied to the (N)-th row LEDs and an amplitude of the (N+1)-th driving current that is applied to the (N+1)-th row LEDs.

For example, the display panel may include an array substrate having a plurality of thin-film transistors (TFTs) that are disposed in a matrix shape, an opposite substrate opposite to the array substrate, and a liquid crystal layer interposed between the array substrate and the opposite substrate. The backlight assembly may provide the display panel with light, so that the amount of light applied to the TFTs does not change as a function of time.

According to an exemplary embodiment of the present invention, driving voltages having a phase delayed by about 360 degrees/M with respect to each other are applied to the (N)-th row LEDs and the (N+1)-th row LEDs, so that dark periods may be prevented when light is generated from the backlight assembly. Furthermore, a striped image may be prevented from being displayed on the display apparatus.

### BRIEF DESCRIPTION OF THE DRAWINGS

Exemplary embodiments of the present invention will be understood in more detail from the following descriptions taken in conjunction with the accompanying drawings, wherein:

FIG. 1 is a cross-sectional view schematically showing a display apparatus according to an exemplary embodiment of the present invention;

FIG. 2 is a plan view showing a backlight assembly according to an exemplary embodiment of the display apparatus of FIG. 1;

FIG. 3 is a plan view showing a backlight assembly according to an exemplary embodiment of the display apparatus of FIG. 1;

FIG. 4 is a circuit diagram showing a first driving element of the backlight assembly of FIG. 1;

FIG. 5A is a cross-sectional view useful in explaining a method of driving the backlight assembly of FIG. 1;

FIG. 5B is a waveform diagram showing a first driving voltage and a second driving voltage that are applied to the backlight assembly shown in FIG. 5A;

FIG. 6A is a cross-sectional view useful in explaining a driving method of a backlight assembly of a display apparatus according to an exemplary embodiment of the present invention;

FIG. 6B is a waveform diagram showing a first driving voltage, a second driving voltage, a third driving voltage and a fourth driving voltage that are applied to the backlight assembly shown in FIG. 6A;

FIG. 7 is a plan view showing a backlight assembly of a display apparatus according to an exemplary embodiment of the present invention; and

FIG. 8 is a plan view showing a backlight assembly of a display apparatus according to an exemplary embodiment of the present invention.

### DESCRIPTION OF EXEMPLARY EMBODIMENTS

The present invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those of ordinary skill in the art.

Exemplary embodiments of the present invention will be described in detail with reference to the accompanying drawings.

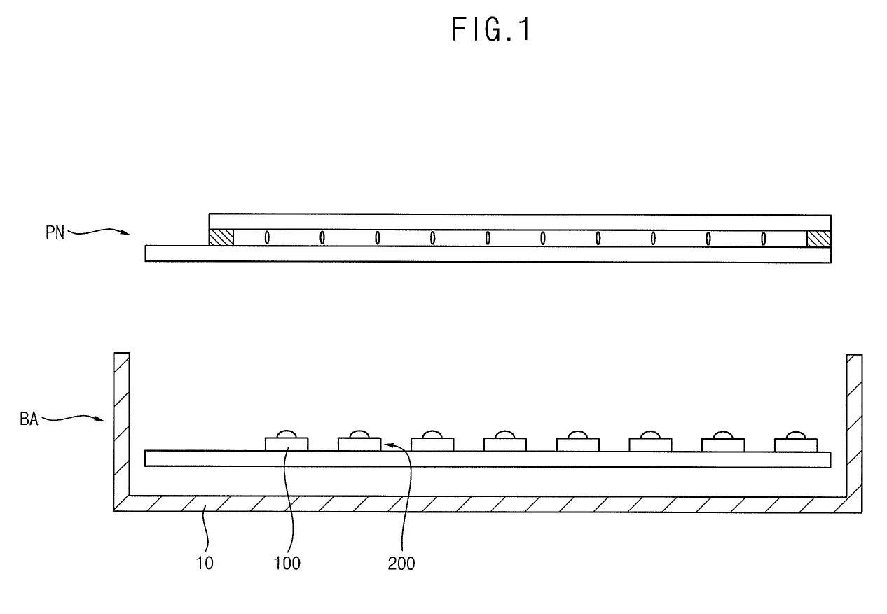

FIG. 1 is a cross-sectional view schematically showing a display apparatus according to an exemplary embodiment of the present invention.

Referring to FIG. 1, a display apparatus of an exemplary embodiment of the present invention includes a display panel PN and a backlight apparatus BA.

The display panel PN is, for example, a liquid crystal display (LCD) panel. That is, the display panel PN may include an array substrate, an opposite substrate and a liquid crystal layer.

The array substrate may include a plurality of signal lines, a plurality of thin-film transistors (TFTs) that are electrically connected to the signal lines, respectively, and a plurality of pixel electrodes that are electrically connected to the TFTs, respectively.

The opposite substrate is disposed opposite the array substrate. The opposite substrate may include a plurality of color filters disposed in correspondence with the pixel electrodes, and a common electrode that is disposed on a full surface thereof. Alternatively, the color filters may be formed on the array substrate.

The liquid crystal layer is interposed between the first and second substrates so as to be altered by an electric field formed between the pixel electrode and the common electrode. When the electric field is applied to the liquid crystal layer, an arrangement of liquid crystal molecules of the liquid crystal layer is altered to thereby change the optical transmissivity, so that an image may be displayed.

The backlight assembly BA is disposed below the display panel PN to provide the display panel PN with light. The backlight assembly BA may include, for example, a driving substrate 100, a light-emitting part 200 disposed on the driving substrate 100, and a receiving container 10 for receiving the driving substrate 100.

In this exemplary embodiment, the backlight assembly BA may provide the display panel PN with light, so that an amount of light applied to the TFTs does not change as a function of time.

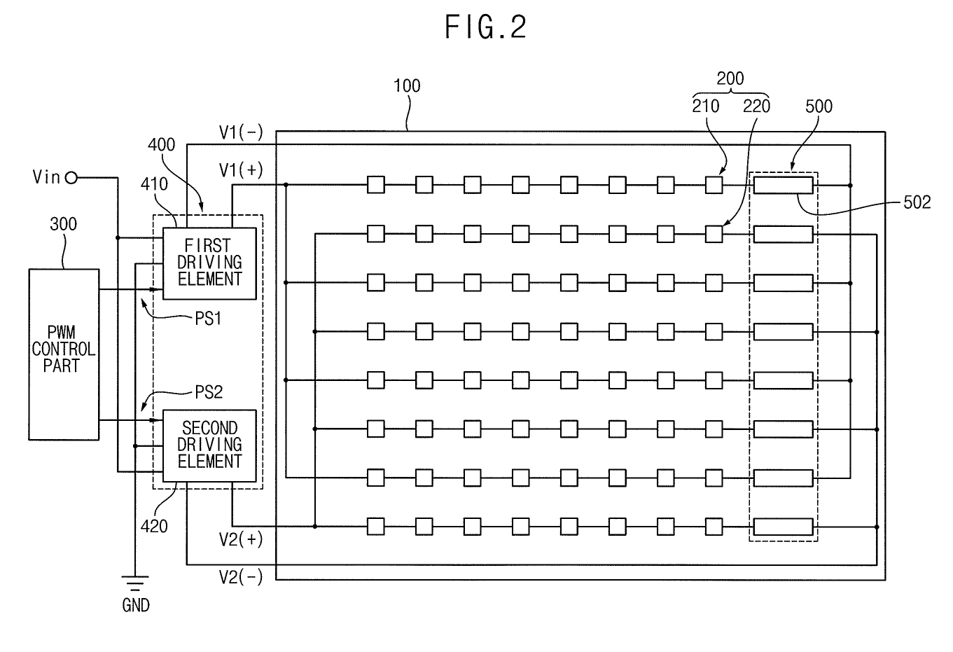

FIG. 2 is a plan view showing a backlight assembly according to an exemplary embodiment of the display apparatus shown in FIG. 1.

Referring to FIG. 2, a backlight assembly of an exemplary embodiment may include the driving substrate 100, the light-emitting part 200, a pulse width modulation (PWM) control part 300, a driving voltage generating part 400, and a current balance part 500.

The driving substrate 100 may be a circuit substrate having a plate shape. A plurality of wirings for providing the light-emitting part 200 with power is formed on the driving substrate 100.

The light-emitting part 200 is disposed on the driving substrate 100 so as to be electrically connected to the wirings. The light-emitting part 200 includes, for example, a plurality of light-emitting diodes (LEDs) that are serially connected to each other. In this exemplary embodiment, the LEDs may be white LEDs, and they may be disposed in a matrix shape. The LEDs disposed along each row may be electrically connected to each other in series.

The light-emitting part 200 includes a plurality of (N)-th row LEDs and a plurality of (N+1)-th row LEDs, wherein ‘N’ is a natural number. When the LEDs are classified into odd numbered LEDs and even numbered LEDs, the light-emitting part 200 may include odd numbered row LEDs 210 and even numbered row LEDs 220. For example, the LEDs may be disposed in eight rows. That is, the light-emitting part 200 includes four odd numbered row LEDs 210 and four even numbered row LEDs 220.

The PWM control part 300 may generate an (N)-th PWM signal for controlling the (N)-th row LEDs and an (N+1)-th PWM signal for controlling the (N+1)-th row LEDs. In this exemplary embodiment, a phase of the (N+1)-th PWM signal is delayed by about 360 degrees/M with respect to that of the (N)-th PWM signal, wherein ‘M’ is a natural number that is more than 2.

For example, the PWM control part 300 may produce a first PWM signal PS1 for controlling the odd numbered row LEDs 210 and a second PWM signal PS2 for controlling the even numbered row LEDs 220. In this exemplary embodiment, a phase of the second PWM signal PS2 is delayed by about 180 degrees with respect to that of the first PWM signal PS1.

The driving voltage-generating part 400 includes an (N)-th driving element and an (N+1)-th driving element. The (N)-th driving element applies an (N)-th driving voltage to the (N)-th row LEDs in response to the (N)-th PWM signal. The (N+1)-th driving element applies an (N+1)-th driving voltage to the (N+1)-th row1LEDs in response to the (N+1)-th PWM signal. As the phase of the (N+1)-th PWM signal is delayed by about 360 degrees/M with respect to that of the (N)-th PWM signal, a phase of the (N+1)-th driving voltage is delayed by about 360 degrees/M with respect to that of the (N+1)-th driving voltage.

For example, the driving voltage generating part 400 includes a first driving element 410 and a second driving element 420. The first driving element 410 applies a first driving voltage V1 to the odd numbered rows, LEDs 210, in response to the first PWM signal PS1. The second driving element 420 applies a second driving voltage V2 to the even numbered rows, LEDs 220, in response to the second PWM signal PS2. In this exemplary embodiment, a phase of the second PWM signal PS2 is delayed by about 180 degrees with respect to that of the first PWM signal PS1.

The driving voltage generating part 400 receives an external applying voltage Vin and a ground voltage GND from an external device (not shown). That is, the external applying voltage Vin and the ground voltage GND are each applied to the first and second driving elements 410 and 420.

The current balance part 500 is electrically connected to the driving voltage generating part 400 and a light-emitting part 200 to control amplitudes of the (N)-th driving current applied to the (N)-th row LEDs and the (N+1)-th driving current applied to the (N+1)-th row LEDs. In one example, the current balance part 500 may be disposed on the driving substrate 100. In another example, the current balance part 500 may be disposed on an additional substrate that is different from the driving substrate 100.

In this exemplary embodiment, the current balance part 500 includes a plurality of current balance elements 502 in correspondence with the LEDs in each row. When the current balance elements 502 are classified into odd numbered rows and even numbered rows, the current balance part 500 includes first balance parts and second balance parts.

The first balance parts are electrically connected to the first driving element 410 and the odd numbered row LEDs 210 to control an amplitude of a first driving current applied to the odd numbered row LEDs 210. The second balance parts are electrically connected to the second driving element 420 and the even numbered row LEDs 220 to control an amplitude of a second driving current applied to the even numbered row LEDs 220. Because the LEDs are disposed in eight rows, each of the first and second balance parts may include four current balance elements 502.

Each of the current balance elements 502 may control an amplitude of a driving current applied to the LEDs in each row. That is, each of the current balance elements 502 may dissipate or emphasize a portion of the driving voltage generated from the driving voltage generating part 400, so as to apply the driving current of a predetermined amplitude to the LEDs in each row. For example, each of the current balance elements 502 increases an amplitude of the driving current when the amplitude of the driving current is less than that of a reference current. Alternatively, each of the current balance elements 502 decreases an amplitude of the driving current when the amplitude of the driving current is greater that of the reference current.

In an exemplary embodiment, the LEDs disposed on the driving substrate 100 may be arranged in a straight line, as shown in FIG. 2, to be electrically connected to each other in series. Alternatively, the LEDs may be arranged in a zigzag shape to be electrically connected to each other in series.

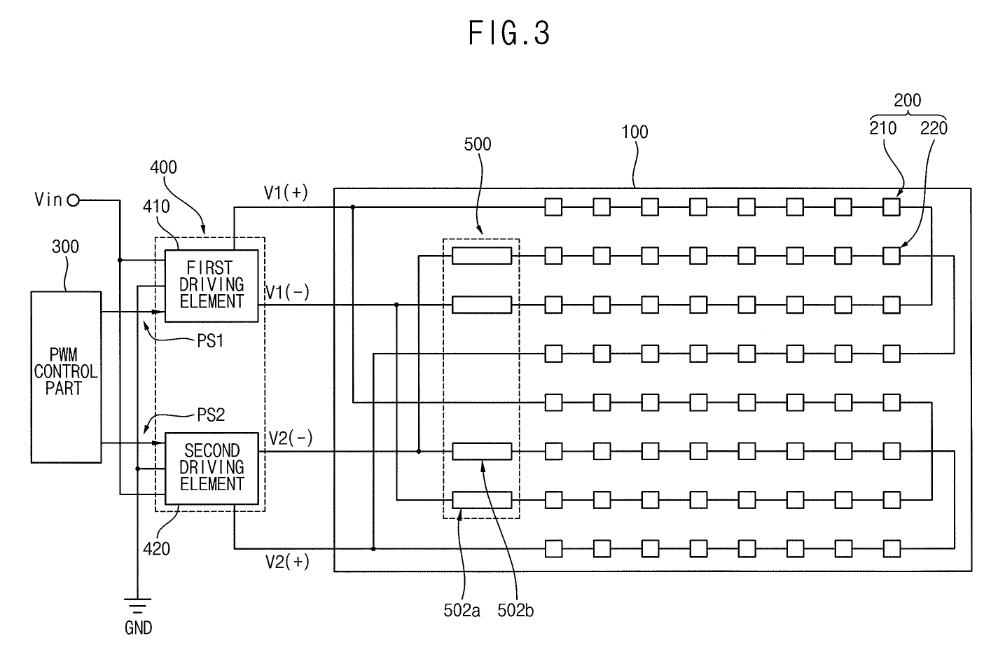

FIG. 3 is a plan view showing a backlight assembly according to an exemplary embodiment of the display apparatus of FIG. 1. The backlight assembly of FIG. 3 is substantially the same as the backlight assembly described with respect to FIG. 2, except for an electrical connection relationship between the LEDs in each row and a current balance section 500. Thus, any further explanation concerning the other elements will be omitted.

Referring to FIG. 3, the current balance section 500 includes a first balance part and a second balance part. The first balance part is electrically connected to the first driving element 410 and the odd numbered row LEDs 210 to control an amplitude of a first driving current that is applied to the odd numbered row LEDs 210. The second balance part is electrically connected to the second driving element 420 and the even numbered row LEDs 220 to control an amplitude of a second driving current that is applied to the even numbered row LEDs 220. The current balance part 500 may be disposed on the driving substrate 100.

The first balance part may include at least one first current balance element 502a that is electrically connected to at least one row of the LEDs of the odd numbered row LEDs 210. The second balance part may include at least one of second current balance element 502b that is electrically connected to at least one row of the LEDs of the even numbered row LEDs 220.

For example, the odd numbered row LEDs 210 may be disposed in four rows. In this exemplary embodiment, first odd row LEDs and second odd row LEDs are electrically connected to each other in series to form a first odd row group, and third odd row LEDs and fourth odd row LEDs are serially and electrically connected to each other to form a second odd row group.

Moreover, the even row LEDs 220 may be disposed in four rows in which the first even row LEDs and second even row LEDs are electrically connected in series to each other to form a first even row group, and third even row LEDs and fourth even row LEDs and electrically connected in series to each other to form a second even row group.

The first balance part includes two first current balance elements 205a that are electrically connected to the first and second odd row groups, and the second balance part includes two second current balance elements 205b that are electrically connected to the first and second even row groups.

That is, one of the first current balance element 502a corresponds to two odd row LEDs 210, and the second current balance element 502b corresponds to two even row LEDs 220. Alternatively, the first current balance element 502a may correspond to at least three odd row LEDs 210, and the second current balance element 502b may correspond to at least three even row LEDs 220.

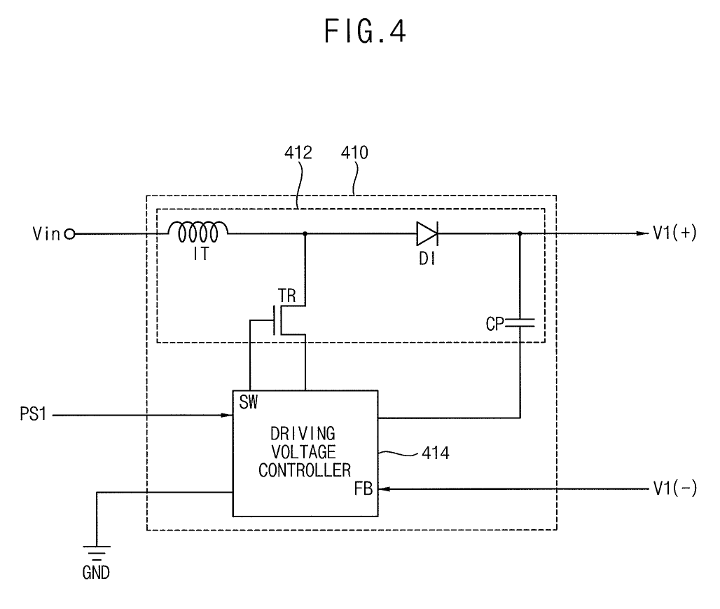

FIG. 4 is a circuit diagram showing a first driving element of the backlight assembly of FIG. 1.

Referring to FIG. 4, an exemplary embodiment of a first driving element 410 may include a voltage changing circuit 412 and a driving voltage controller 414.

The voltage changing circuit 412 increases or decreases an external applying voltage Vin applied from an external device (not shown), and generates a driving voltage V1. The voltage changing circuit 412 may include, for example, an inductor IT, a diode DI, a transistor TR, and a capacitor CP.

The inductor IT includes a first terminal receiving the external voltage Vin, and a second terminal electrically connected to a first terminal of the diode DI and a first terminal of the transistor TR. The diode DI includes a first terminal electrically connected to a first terminal of the capacitor CP, and a second terminal receiving the ground voltage GND through the driving voltage controller 414 and the transistor TR. A second terminal of the transistor TR may receive the ground voltage GND through the driving voltage controller 414.

The second terminal of the diode DI may output a positive first driving voltage V1+, and a feedback terminal FB of the driving voltage controller 414 may receive a negative first driving voltage V1−. A switching terminal SW of the driving voltage controller 414 is electrically connected to a control terminal of the transistor TR to control the transistor TR.

The driving voltage controller 414 may control the voltage changing circuit 412 in response to the first PWM signal PS1 applied from the PWM control part 300 shown in FIGS. 2 and 3. That is, the driving voltage controller 414 controls the transistor TR to control ON/OFF of outputting the first driving voltage V1.

As elements included in the second driving element 420 are substantially the same as elements included in the first driving element 410, any further explanation concerning the above elements of the second driving element 420 will be omitted.

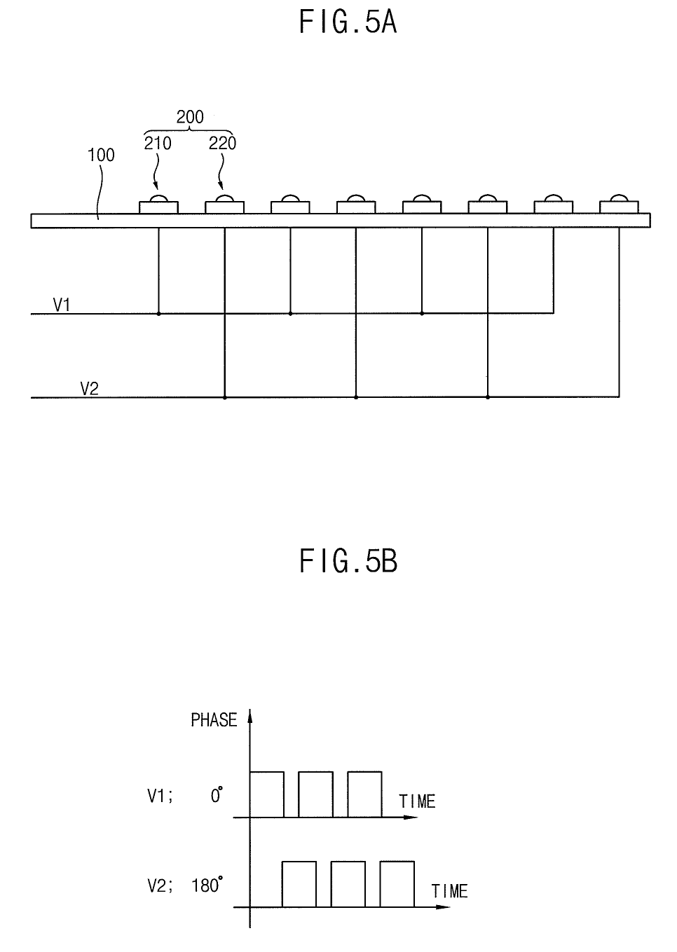

FIG. 5A is a cross-sectional view useful in explaining a method of driving the backlight assembly shown in FIG. 1. FIG. 5B is a waveform diagram showing a first driving voltage and a second driving voltage that are applied to the backlight assembly of FIG. 5A.

Referring to FIGS. 5A and 5B, the first driving voltage V1 is applied to the odd row LEDs 210, and the second driving voltage V2, having a phase delayed by about 180 degrees with respect to that of the second driving voltage V1, is applied to the even row LEDs 220.

Accordingly, when the odd row LEDs 210 and the even row LEDs 220 are driven in a phase delayed by about 180 degrees with respect to each other, the backlight assembly may generate uniform light without any dark periods. Therefore, a striped image may be prevented from being displayed on the display apparatus.

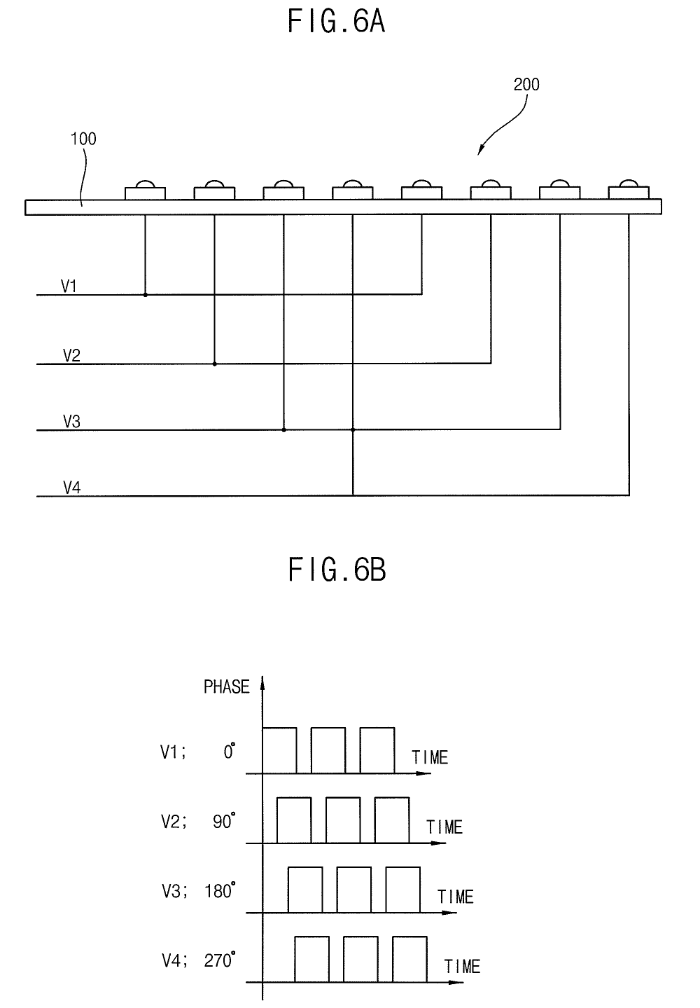

FIG. 6A is a cross-sectional view useful in explaining a driving method of a backlight assembly of a display apparatus according to an exemplary embodiment of the present invention. FIG. 6B is a waveform diagram showing a first driving voltage, a second driving voltage, a third driving voltage and a fourth driving voltage that are applied to the backlight assembly of FIG. 6A.

Referring to FIGS. 6A and 6B, a light-emitting part 200 according to an exemplary embodiment includes a plurality of row LEDs, for example, eight rows of LEDs, which are disposed on the driving substrate 100.

In this exemplary embodiment, LEDs in adjacent rows are driven in a phase delayed by about 90 degrees. For example, first and fifth rows of LEDs receive a first driving voltage V1, and second and sixth rows of LEDs receive a second driving voltage V2 having a phase delayed by about 90 degrees with respect to the phase of the first driving voltage V1. Third and seventh rows of LEDs receive a third driving voltage V3 having a phase delayed by about 90 degrees with respect to the phase of the second driving voltage V2, and fourth and eighth rows of LEDs receive a fourth driving voltage V4 having a phase delayed by about 90 degrees with respect to the phase of the third driving voltage V3.

Accordingly, when the LEDs in adjacent rows are driven in a phase delayed by about 90 degrees with respect to each other, the backlight assembly may generate uniform light without producing any dark periods. Therefore, a striped image may be prevented from being displayed on the display apparatus.

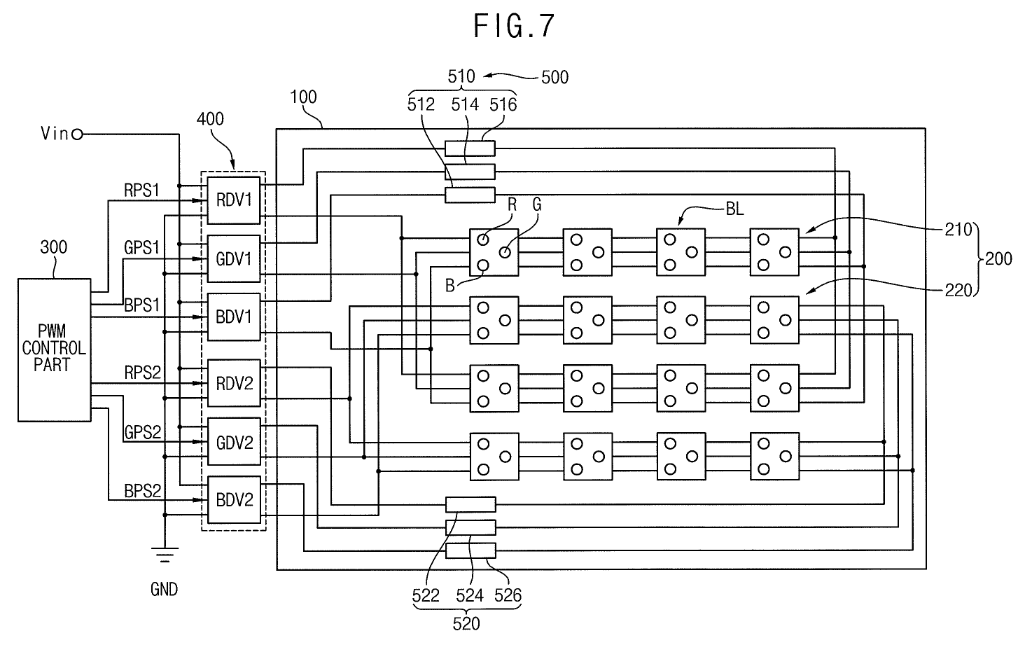

FIG. 7 is a plan view showing a backlight assembly of a display apparatus according to an exemplary embodiment of the present invention.

Referring to FIG. 7, a backlight assembly according to an exemplary embodiment includes a driving substrate 100, a light-emitting part 200, a PWM control part 300, a driving voltage-generating part 400, and a current balance part 500.

The driving substrate 100 includes a plurality of wires for providing the light-emitting part 200 with power.

The light-emitting part 200 includes a plurality of light-emitting blocks BL arranged in a plurality of rows. Each of the light-emitting blocks BL may include a red diode R, a green diode G and a blue diode B. That is, the light-emitting part 200 includes (N)-th row light-emitting blocks and (N+1)-th row light-emitting blocks, wherein ‘N’ is a natural number.

The (N)-th row light-emitting blocks include (N)-th row red LEDs that are connected to each other in series, (N)-th row green LEDs that are connected to each other in series, and (N)-th row blue LEDs that are serially connected to each other.

Furthermore, the (N+1)-th row light-emitting blocks include (N+1)-th row red LEDs that are connected to each other in series, (N+1)-th row green LEDs that are connected to each other in series, and (N+1)-th row blue LEDs that are serially connected to each other.

For example, the light-emitting part 200 may include two odd numbered rows of light-emitting blocks 210 and two even numbered rows of light-emitting blocks 220. In this exemplary embodiment, each of the odd numbered row light-emitting blocks 210 includes odd numbered row red LEDs, odd numbered row green LEDs, and odd numbered row blue LEDs. Each of the even numbered row light-emitting blocks 220 includes even numbered row red LEDs, even numbered row green LEDs, and even numbered row blue LEDs.

The PWM control part 300 generates an (N)-th PWM signal for controlling the (N)-th row light-emitting blocks, and an (N+1)-th PWM signal for controlling the (N+1)-th row light-emitting blocks.

The (N)-th PWM signal includes an (N)-th red PWM signal for controlling the (N)-th row red LEDs, an (N)-th green PWM signal for controlling the (N)-th row green LEDs, and an (N)-th blue PWM signal for controlling the (N)-th row blue LEDs.

The (N+1)-th PWM signal includes an (N+1)-th red PWM signal for controlling the (N+1)-th row red LEDs, a (N+1)-th green PWM signal for controlling the (N+1)-th row green LEDs, and an (N+1)-th blue PWM signal for controlling the (N+1)-th row blue LEDs.

For example, the PWM control part 300 may generate a first PWM signal for controlling the odd numbered row light-emitting blocks 210, and a second PWM signal for controlling the even numbered row light-emitting blocks 220.

The first PWM signal may include a first red PWM signal RPS1 for controlling the odd numbered row red LEDs, a first green PWM signal GPS1 for controlling the odd numbered row green LEDs, and a first blue PWM signal BPS1 for controlling the odd numbered row blue LEDs.

Moreover, the second PWM signal may include a second red PWM signal RPS2 for controlling the even numbered row red LEDs, a second green PWM signal GPS2 for controlling the even numbered row green LEDs, and a second blue PWM signal BPS2 for controlling the even numbered row blue LEDs.

The driving voltage-generating part 400 includes an (N)-th driving element applying an (N)-th driving voltage to the (N)-th row light-emitting blocks in response to the (N)-th PWM signal, and an (N+1)-th driving element applying an (N+1)-th driving voltage to the (N+1)-th row light-emitting blocks in response to the (N+1)-th PWM signal. A phase of the (N+1)-th driving voltage is delayed by about 360 degrees/M with respect to that of the (N)-th driving voltage, wherein ‘M’ is a natural number that is more than 2.

The (N)-th driving element includes an (N)-th red driving element that applies an (N)-th red driving voltage to the (N)-th row red LEDs in response to the (N)-th red PWM signal, an (N)-th green driving element that applies a (N)-th green driving voltage to the (N)-th row green LEDs in response to the (N)-th green PWM signal, and an (N)-th blue driving element that applies an (N)-th blue driving voltage to the (N)-th row blue LEDs in response to the (N)-th blue PWM signal.

Moreover, the (N+1)-th driving element includes an (N+1)-th red driving element that applies an (N+1)-th red driving voltage to the (N+1)-th row red LEDs in response to the (N+1)-th red PWM signal, an (N+1)-th green driving element that applies a (N+1)-th green driving voltage to the (N+1)-th row green LEDs in response to the (N+1)-th green PWM signal, and an (N+1)-th blue driving element that applies a (N+1)-th blue driving voltage to the (N+1)-th row blue LEDs in response to the (N+1)-th blue PWM signal. A phase of the (N+1)-th red driving voltage is delayed by about 360 degrees/M with respect to the phase of the (N)-th red driving voltage. A phase of the (N+1)-th green driving voltage is delayed by about 360 degrees/M with respect to that of the (N)-th green driving voltage. A phase of the (N+1)-th blue driving voltage is delayed by about 360 degrees/M with respect to the phase of the (N)-th blue driving voltage.

For example, the driving voltage generating part 400 includes a first driving element that applies a first driving voltage to the odd numbered row light-emitting blocks 210 in response to the first PWM signal, and a second driving element that applies a second driving voltage to the even numbered row light-emitting blocks 220 in response to the second PWM signal. A phase of the second driving voltage is delayed by about 180 degrees with respect to the phase of the first driving voltage. An external applying voltage Vin and a ground voltage GND may be applied to the first and second driving elements.

The first driving element may include a first red driving element RDV1 that applies a first red driving voltage to the odd numbered row red LEDs in response to the first red PWM signal RPS1, a first green driving element GDV1 that applies a first green driving voltage to the odd numbered row green LEDs in response to the first green PWM signal RPS1, and a first blue driving element BDV1 that applies a first blue driving voltage to the odd numbered row blue LEDs in response to the first blue PWM signal BPS1.

Furthermore, the second driving element may include a second red driving element RDV2 that applies a second red driving voltage to the even numbered row red LEDs in response to the second red PWM signal RPS2, a second green driving element GDV2 that applies a second green driving voltage to the even numbered row green LEDs in response to the second green PWM signal RPS2, and a second blue driving element BDV2 that applies a second blue driving voltage to the even numbered row blue LEDs in response to the second blue PWM signal BPS2.

The current balance part 500 is electrically connected to the driving voltage generating part 400 and the light-emitting part 200 to control an amplitude of the (N)-th driving current that is applied to the (N)-th row light-emitting blocks and an amplitude of the (N+1)-th driving current that is applied to the (N+1)-th row light-emitting blocks.

The (N)-th driving current includes an (N)-th red driving current that is applied to the (N)-th row red LEDs, an (N)-th green driving current that is applied to the (N)-th row green LEDs, and an (N)-th blue driving current that is applied to the (N)-th row blue LEDs.

The (N+1)-th driving current includes an (N+1)-th red driving current that is applied to the (N+1)-th row red LEDs, an (N+1)-th green driving current that is applied to the (N+1)-th row green LEDs, and an (N+1)-th blue driving current that is applied to the (N+1)-th row blue LEDs.

The current balance part 500 includes an (N)-th balance part that controls amplitudes of the (N)-th red, green and blue driving currents, respectively, and an (N+1)-th balance part that controls amplitudes of the (N+1)-th red, green and blue driving currents, respectively.

For example, the current balance part 500 may control amplitudes of the first driving current that is applied to the odd numbered row light-emitting blocks and amplitudes of the second driving current that is applied to the even numbered row light-emitting blocks.

The first driving current may include a first red driving current that is applied to the odd numbered row red LEDs, a first green driving current that is applied to the odd numbered row green LEDs, and a first blue driving current that is applied to the odd numbered row blue LEDs.

Furthermore, the second driving current may include a second red driving current that is applied to the even numbered row red LEDs, a second green driving current that is applied to the even numbered row green LEDs, and a second blue driving current that is applied to the even numbered row blue LEDs.

In this exemplary embodiment, the current balance part 500 includes a first balance part 510 that controls amplitudes of the first red, green and blue driving currents, and a second balance part 520 that controls amplitudes of the second red, green and blue driving currents.

The first balance part 510 may include a first red balance element 512 that controls amplitudes of the first red driving current, a first green balance element 514 that controls amplitudes of the first green driving current, and a first blue balance element 516 that controls amplitudes of the first blue driving current.

The second balance part 520 may include a second red balance element 522 that controls amplitudes of the second red driving current, a second green balance element 524 that controls amplitudes of the second green driving current, and a second blue balance element 526 that controls amplitudes of the second blue driving current.

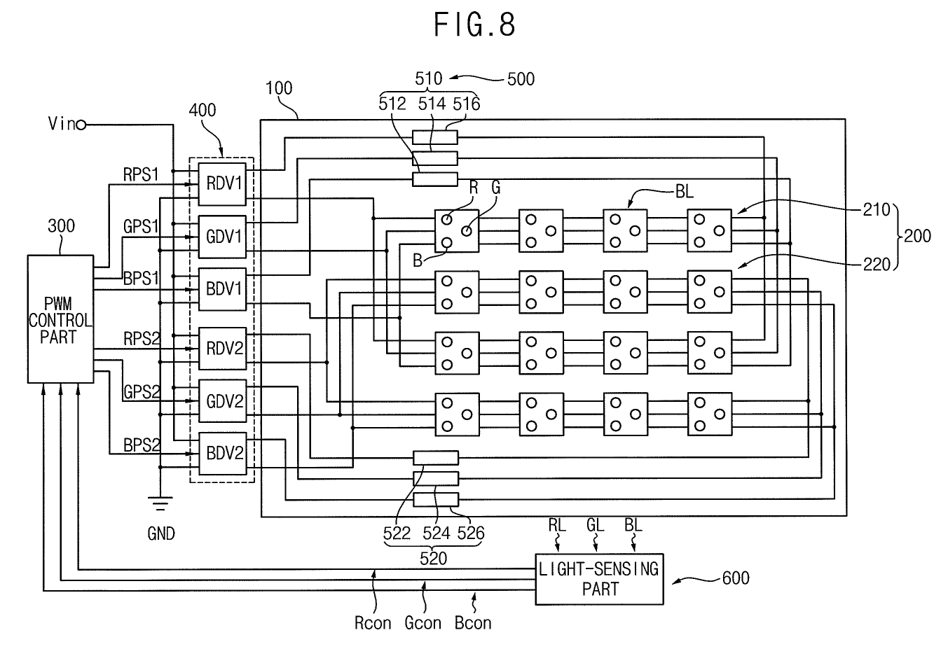

FIG. 8 is a plan view showing a backlight assembly of a display apparatus according to an exemplary embodiment of the present invention. The backlight assembly of FIG. 8 is substantially the same as the backlight assembly described with respect to FIG. 7 except for a light-sensing part 600. Thus, any further explanation concerning the common elements will be omitted.

Referring to FIG. 8, a light-sensing part 600 may sense each of a red light RL, a green light GL and a blue light BL, which are generated from the light-emitting part 200.

The light-sensing part 600 may provide the PWM control part 300 with a red control signal Rcon based on sensing the red light RL to control an amplitude of the red light RL, a green control signal Gcon based on sensing the green light GL to control an amplitude of the green light GL, and a blue control signal Bcon based on sensing the blue light BL to control an amplitude of the blue light BL.

The PWM control part 300 may control the driving voltage generating part 400 to control respective amplitudes of the red light RL, a green light BL and a blue light BL in response to the red control signal Rcon, the green control signal Gcon, and the blue control signal Bcon.

In this exemplary embodiment, respective amplitudes of the red, green, and blue lights RL, GL, and BL may be changed in proportion to a variation of the pulse width or an amplitude of the driving current that is applied to the light-emitting part 200.

Accordingly, when the light-sensing part 600 senses each of the red light RL, the green light GL, and the blue light BL that are generated from the light-emitting part 200 to control amplitudes of the red light RL, the green light GL, and the blue light BL, respectively, the backlight assembly BA may generate white light having desired color coordinates.

Although the exemplary embodiments of the present invention have been described, it is understood that the present invention should not be limited to these exemplary embodiments but various changes and modifications can be made by one of ordinary skill in the art within the spirit and scope of the present invention, as hereinafter claimed.

What is claimed is:

1. A backlight assembly comprising:
a light-emitting part including a plurality of (N)-th row light-emitting diodes (LEDs) that are connected to each other in series, and a plurality of (N+1)-th row LEDs that are connected to each other in series, wherein ‘N’ is a natural number;
a pulse width modulation (PWM) control part generating an (N)-th PWM signal for controlling the (N)-th row LEDs, and an (N+1)-th PWM signal for controlling the (N+1)-th row LEDs;
a driving voltage generating part including an (N)-th driving element that applies an (N)-th driving voltage to the (N)-th row LEDs in response to the (N)-th PWM signal, and an (N+1)-th driving element that applies an (N+1)-th driving voltage to the (N+1)-th row LEDs in response to the (N+1)-th PWM signal, wherein a phase of the (N+1)-th driving voltage is delayed by about 360 degrees/M with respect to a phase of the first driving voltage, wherein ‘M’ is a natural number that is more than 2; and
a current balance part being electrically connected to the driving voltage generating part and the light-emitting part to control an amplitude of an (N)-th driving current that is applied to the (N)-th row LEDs and an amplitude of an (N+1)-th driving current that is applied to the (N+1)-th row LEDs.

2. The backlight assembly of claim 1, wherein the PWM control part controls the driving voltage generating part, so that the LEDs that are disposed in each row receive a driving voltage having a phase equal to the (N)-th row.

3. The backlight assembly of claim 2, wherein the light-emitting part comprises even numbered row LEDs and odd numbered row LEDs,
the PWM control part generates a first PWM signal for controlling the odd numbered row LEDs and a second PWM signal for controlling the even numbered row LEDs, and
the driving voltage generating part comprises a first driving element that applies a first driving voltage to the odd numbered row LEDs in response to the first PWM signal and a second driving element that applies a second driving voltage to the even numbered row LEDs in response to the second PWM voltage, wherein a phase of the second driving voltage is delayed by about 180 degrees with respect to a phase of the first driving voltage.

4. The backlight assembly of claim 3, wherein the current balance part comprises:
a first balance part being electrically connected to the first driving element and the odd numbered row LEDs to control an amplitude of a first driving current that is applied to the odd numbered row LEDs; and
a second balance part being electrically connected to the second driving element and the even numbered row LEDs to control an amplitude of a second driving current that is applied to the even numbered row LEDs.

5. The backlight assembly of claim 4, wherein the first balance part comprises at least one of first current balance elements electrically connected to the odd numbered row LEDs, and
the second balance part comprises at least one of second current balance elements electrically connected to the even numbered row LEDs.

6. The backlight assembly of claim 5, wherein each of the first current balance elements is electrically connected to two LEDs of the odd numbered row LEDs, that are connected to each other in series and adjacent each other, and
each of the second current balance elements is electrically connected to two LEDs of the even numbered row LEDs that are connected to each other in series and adjacent each other.

7. The backlight assembly of claim 1, wherein the (N)-th row LEDs comprise:
a plurality of (N)-th row red LEDs that are connected to each other in series;
a plurality of (N)-th row green LEDs that are connected to each other in series; and
a plurality of (N)-th row blue LEDs that are connected to each other in series, and the (N+1)-th row LEDs comprises:
a plurality of (N+1)-th row red LEDs that are connected to each other in series;
a plurality of (N+1)-th row green LEDs that are connected to each other in series; and
a plurality of (N+1)-th row blue LEDs that are connected to each other in series.

8. The backlight assembly of claim 1, wherein the (N)-th PWM signal comprises:
an (N)-th red PWM signal for controlling the (N)-th row red LEDs;
an (N)-th green PWM signal for controlling the (N)-th row green LEDs; and
an (N)-th blue PWM signal for controlling the (N)-th row blue LEDs, and the (N+1)-th PWM signal comprises:
an (N+1)-th red PWM signal for controlling the (N+1)-th row red LEDs;
an (N+1)-th green PWM signal for controlling the (N+1)-th row green LEDs; and
an (N+1)-th blue PWM signal for controlling the (N+1)-th row blue LEDs.

9. The backlight assembly of claim 8, wherein the (N)-th driving element comprises:
an (N)-th red driving element applying an (N)-th red driving voltage to the (N)-th row red LEDs in response to the (N)-th red PWM signal;
an (N)-th green driving element applying an (N)-th green driving voltage to the (N)-th row green LEDs in response to the (N)-th green PWM signal; and
an (N)-th blue driving element applying an (N)-th blue driving voltage to the (N)-th row blue LEDs in response to the (N)-th blue PWM signal, and the (N+1)-th driving element comprises:
an (N+1)-th red driving element applying an (N+1)-th red driving voltage to the (N+1)-th row red LEDs in response to the (N+1)-th red PWM signal, wherein a phase of the (N+1)-th red driving voltage is delayed by about 360 degrees/M with respect to a phase of the (N)-th red driving voltage;
an (N+1)-th green driving element applying an (N+1)-th green driving voltage to the (N+1)-th row green LEDs in response to the (N+1)-th green PWM signal, wherein a phase of the (N+1)-th green driving voltage is delayed by about 360 degrees/M with respect to a phase of the (N)-th green driving voltage; and
an (N+1)-th blue driving element applying an (N+1)-th blue driving voltage to the (N+1)-th row blue LEDs in response to the (N+1)-th blue PWM signal, wherein a phase of the (N+1)-th blue driving voltage is delayed by about 360 degrees/M with respect to a phase of the (N)-th blue driving voltage.

10. The backlight assembly of claim 9, wherein the (N)-th driving current comprises an (N)-th red driving current that is applied to the (N)-th row red LEDs, an (N)-th green driving current that is applied to the (N)-th row red LEDs, and an (N)-th blue driving current that is applied to the (N)-th row red LEDs, and
the (N+1)-th driving current comprises an (N+1)-th red driving current that is applied to the (N+1)-th row red LEDs, an (N+1)-th green driving current that is applied to the (N+1)-th row red LEDs, and an (N+1)-th blue driving current that is applied to the (N+1)-th row red LEDs.

11. The backlight assembly of claim 10, wherein the current balance part comprises:
an (N)-th balance part controlling amplitudes of the (N)-th red driving current, the (N)-th green driving current and the (N)-th blue driving current, respectively; and
an (N+1)-th balance part controlling amplitudes of the (N+1)-th red driving current, the (N+1)-th green driving current and the (N+1)-th blue driving current, respectively.

12. The backlight assembly of claim 1, further comprising a light-sensing part sensing a red light, a green light and a blue light that are emitted from the light-emitting part and generating a red light control signal for controlling an amplitude of the red light, a green light control signal for controlling an amplitude of the green light and a blue light control signal for controlling an amplitude of the blue light,
wherein the PWM control part controls the driving voltage generating part to control the amplitudes of the red, green and blue lights in response to the red light control signal, the green light control signal and the blue light control signal.

13. The backlight assembly of claim 1, further comprising a driving substrate having the light-emitting part disposed thereon,
wherein the current balance part is disposed on the driving substrate.

14. The backlight assembly of claim 1, wherein a driving element, which is disposed in the driving voltage-generating part, comprises:
a voltage changing circuit that increases or decreases an external voltage to output a driving voltage; and
a driving voltage controller that controls the voltage changing circuit to control an outputting of the driving voltage in response to a PWM signal applied from the PWM control part.

15. A display apparatus comprising:
a backlight assembly emitting light; and
a display panel displaying an image using the light generated from the backlight assembly, wherein the backlight assembly comprises:
a light-emitting part including a plurality of (N)-th row light-emitting diodes (LEDs) that that connected to each other in series, and a plurality of (N+1)-th row LEDs that that connected to each other in series, wherein ‘N’ is a natural number;
a pulse width modulation (PWM) control part generating an (N)-th PWM signal for controlling the (N)-th row LEDs, and an (N+1)-th PWM signal for controlling the (N+1)-th row LEDs;
a driving voltage generating part including an (N)-th driving element that applies an (N)-th driving voltage to the (N)-th row LEDs in response to the (N)-th PWM signal, and an (N+1)-th driving element that applies an (N+1)-th driving voltage to the (N+1)-th row LEDs in response to the (N+1)-th PWM signal, wherein a phase of the (N+1)-th driving voltage is delayed by about 360 degrees/M with respect to a phase of the first driving voltage, wherein ‘M’ is a natural number that is more than 2; and
a current balance part being electrically connected to the driving voltage generating part and the light-emitting part to control an amplitude of an (N)-th driving current that is applied to the (N)-th row LEDs and an amplitude of an (N+1)-th driving current that is applied to the (N+1)-th row LEDs.

16. The display apparatus of claim 15, wherein the PWM control part controls the driving voltage generating part, so that the LEDs that are disposed in each row receive a driving voltage having a phase equal to the (N)-th row.

17. The display apparatus of claim 16, wherein the light-emitting part comprises even numbered row LEDs and odd numbered row LEDs,
the PWM control part generates a first PWM signal for controlling the odd numbered LEDs and a second PWM signal for controlling the even numbered LEDs, and
the driving voltage generating part comprises a first driving element that applies a first driving voltage to the odd numbered row LEDs in response to the first PWM signal and a second driving element that applies a second driving voltage to the even numbered row LEDs in response to the second PWM voltage, wherein a phase of the second driving voltage is delayed by about 180 degrees with respect to a phase of the first driving voltage.

18. The display apparatus of claim 17, wherein the current balance part comprises:
a first balance part being electrically connected to the first driving element and the odd numbered row LEDs to control an amplitude of a first driving current that is applied to the odd numbered row LEDs; and
a second balance part being electrically connected to the second driving element and the even numbered LEDs to control an amplitude of a second driving current that is applied to the even numbered row LEDs.

19. The display apparatus of claim 15, wherein the display panel comprises:
an array substrate having a plurality of thin-film transistors (TFTs) that are disposed in a matrix shape;
an opposite substrate opposite to the array substrate; and
a liquid crystal layer interposed between the array substrate and the opposite substrate.

20. The display apparatus of claim 19, wherein the backlight assembly provides the display panel with the light, so that an amount of light applied to the TFTs does not change as a function of time.
